(19) United States
(12) Patent Application Publication
(10) Pub. No.: US 2026/0312249 A1
(43) Pub. Date: Oct. 8, 2026

(54) CYLINDRICAL BATTERY CELL

(71) Applicant: SK On Co., Ltd., Seoul (KR)

(72) Inventors: Byeong Jun PAK, Daejeon (KR); Seung Hoon JU, Daejeon (KR); Yang Kyu CHOI, Daejeon (KR)

(21) Appl. No.: 19/636,927

(22) Filed: Apr. 2, 2026

(30) Foreign Application Priority Data
Apr. 2, 2025 (KR) 10-2025-0042807

(51) Int. Cl. H01M 50/534; H01M 50/107; H01M 50/152; H01M 50/533; H01M 50/547

(52) U.S. Cl. CPC H01M 50/534; H01M 50/107; H01M 50/152; H01M 50/533; H01M 50/547

(57) ABSTRACT

The present disclosure relates to a cylindrical battery cell, and more specifically, to a cylindrical battery cell in which a current collector may be prevented from being spaced apart from a bottom plate of a can of the cylindrical battery cell. Further, a current collector and a bottom plate of a can are magnetically coupled, the can and the current collector do not need to be welded on the inside of the can.

### CROSS-REFERENCE TO RELATED PATENT APPLICATION

The present application claims priority under 35 U.S.C. § 119(a) to Korean patent application number 10-2025-0042807 filed on Apr. 2, 2025, in the Ministry of Intellectual Property, the entire disclosure of which is incorporated by reference herein.

### BACKGROUND OF THE INVENTION

### 1. Field

The present disclosure relates to a cylindrical battery cell, and more specifically, to a cylindrical battery cell in which a current collector may be prevented from being spaced apart from a bottom plate of a can of the cylindrical battery cell.

### 2. Description of the Related Art

A cylindrical battery cell may accommodate an electrode assembly that includes a first electrode and a second electrode inside a can which is an exterior material, with a configuration that allows the can to be electrically connected to the first electrode and an electrode terminal to be electrically connected to the second electrode.

In order to electrically connect the first electrode and a current collector, a first electrode uncoated portion, which is a portion of the first electrode not coated with a first electrode active material layer, needs to be joined to the current collector by welding, while a portion of the current collector needs to be joined to an inner circumferential surface of the can.

In order to electrically connect the current collector with the can, a method of forming a bend at a lower portion of the can and welding a part of the current collector to an inner circumferential surface of the bend through an open lower portion of the can has been used conventionally. Further, the lower portion of the can is sealed by joining the bottom plate to the bend that is formed at the lower portion of the can.

Likewise, when the can and the current collector are welded on the inside of the can, however, there rises a problem in that metal debris caused by the welding may remain inside the can, or the electrode assembly arranged inside of the can may be damaged by heat from welding.

In addition, the manufacturing cost of a cylindrical battery cell increases because a process is required to form a bend in the lower portion of the can, and the volume of the internal space of the can becomes smaller as the bend is formed in the lower portion of the can, leading to reduction in the energy density of the cylindrical battery cell.

Therefore, it is necessary to develop a cylindrical battery cell in which the current collector and the can may be in a reliable electrical connection without welding the can and the current collector on the inside of the can.

### SUMMARY OF THE INVENTION

An object of the present disclosure is to provide a cylindrical battery cell in which metal debris is prevented from remaining inside the can and damage to an electrode assembly is avoided.

Another object of the present disclosure is to provide a cylindrical battery cell in which the energy density may be increased.

Another object of the present disclosure is to provide a cylindrical battery cell that ensures reduced manufacturing costs.

The cylindrical battery cell of the present disclosure may be widely used in green technologies that utilize batteries, such as electric vehicles. Furthermore, the cylindrical battery cell of the present disclosure may be used in eco-friendly electric vehicles, hybrid vehicles, or the like to prevent climate change by curbing air pollution and greenhouse gas emissions.

As a technical means to solve the aforementioned technical objects, a cylindrical battery cell according to an embodiment of the present disclosure may include: a can formed in a cylindrical shape with an open top to have a receiving space formed therein, and having a bottom plate positioned at a lower portion and formed of a magnetic material; an electrode assembly including a first electrode including a first electrode uncoated portion excluding a portion on which a first electrode active material layer is formed and a second electrode including a second electrode uncoated portion excluding a portion on which a second electrode active material layer is formed, wherein a separator is stacked between the first electrode and the second electrode, and accommodated in the receiving space; a current collector coupled to the first electrode uncoated portion to be in electrical connection, including a current collector plate having at least a portion coming in contact with the bottom plate to be in electrical connection, and arranged between the electrode assembly and the bottom plate; and a cap assembly including an electrode terminal electrically connected to the second electrode uncoated portion and coupled to a top of the can to seal the receiving space, wherein the current collector may further include a magnet and may be prevented from being spaced apart from the bottom plate by an attractive force acting between the magnet and the bottom plate.

In addition, the current collector plate may include a coupling portion having the first electrode uncoated portion coupled thereto and a seating portion located on an outer circumference of the coupling portion, wherein the magnet may be arranged to oppose the bottom plate with at least a portion of the seating portion interposed therebetween to exert an attractive force to the bottom plate.

In addition, the coupling portion may be formed in a disk shape, wherein the seating portion may be formed in a ring shape surrounding an outer circumference of the coupling portion.

In addition, the seating portion may be formed to come in contact with the bottom plate, wherein the coupling portion may be formed to have a step with the seating portion to be spaced a predetermined distance from the bottom plate when the seating portion comes in contact with the bottom plate, wherein at least one or more through holes may be formed in the coupling portion, and wherein the first electrode uncoated portion may be passed through the through holes and then folded to be coupled to the coupling portion with the coupling portion interposed therebetween.

In addition, the magnet may be formed in a ring shape and may be arranged to oppose the bottom plate, with the seating portion interposed therebetween.

In addition, the current collector may further include, to prevent the magnet from being spaced apart from the seating portion, a support plate which is engaged with the coupling portion to support the magnet.

In addition, at least one or more engagement grooves may be formed in the coupling portion, wherein the support plate may include a support supporting the magnet and an engaged portion engaged with the engagement groove.

In addition, the current collector plate may include a coupling portion having the first electrode uncoated portion coupled thereto and formed to come in contact with the bottom plate, and a seating portion located on an outer circumference of the coupling portion and formed to have a step with the coupling portion to be spaced a predetermined distance from the bottom plate when the coupling portion comes in contact with the bottom plate, wherein the magnet may be coupled to at least a portion of the seating portion to exert an attractive force to the bottom plate.

In addition, the coupling portion may be formed in a disk shape, wherein the seating portion may be formed in a ring shape surrounding an outer circumference of the coupling portion.

In addition, the magnet may be formed in a ring shape to be coupled to the seating portion.

In addition, the current collector may further include, to prevent the magnet from being spaced apart from the seating portion, a support plate engaged with the coupling portion to support the magnet.

In addition, at least one or more engagement grooves may be formed in the coupling portion, and the support plate may include a support supporting the magnet and an engaged portion engaged with the engagement groove.

In addition, the magnet may be a ferrite magnet or a neodymium magnet.

In addition, the bottom plate may include a first magnet that exerts an attractive force to the magnet.

In addition, the first magnet may be arranged inside the bottom plate.

Further details of other embodiments to address the objects are included in the description and drawings of the disclosure.

According to the above-described means of solving the problems of the present disclosure, in a cylindrical battery cell according to the present disclosure, as a current collector and a bottom plate of a can are magnetically coupled, the can and the current collector do not need to be welded on the inside of the can, thereby providing effects that metal debris is prevented from remaining inside the can and an electrode assembly is avoided from being damaged by heat from welding.

Furthermore, a bend for welding the current collector to an inner circumference of the can is not required to be formed at a lower portion of the can, such that a volume of an inner space of the can is increased, thereby leading to an increase in the energy density.

In addition, there is no need to perform a process to form a bend at a lower portion of the can for welding the current collector to an inner surface of the can, thereby reducing manufacturing costs.

### BRIEF DESCRIPTION OF THE DRAWINGS

FIG. 1 is a cross-sectional view illustrating a cylindrical battery cell according to an embodiment of the present disclosure.

FIG. 2 is a perspective view illustrating a can.

FIG. 3 is a perspective view illustrating a current collector.

FIG. 4 is a perspective view illustrating an example of a current collector plate.

FIG. 5 is a diagram illustrating a view in which a magnet is arranged in a current collector plate according to an example.

FIG. 6 is a perspective view illustrating another example of a current collector plate.

FIG. 7 is a diagram illustrating a view in which a magnet is arranged in a current collector plate according to another example.

FIG. 8 is an exploded perspective view illustrating an example of a current collector including a support plate.

FIG. 9 is a perspective view illustrating an example of a current collector to which a support plate is engaged with a coupling portion.

FIG. 10 is an exploded perspective view illustrating another example of a current collector including a support plate.

FIG. 11 is a perspective view illustrating another example of a current collector to which a support plate is engaged with a coupling portion.

FIG. 12 is a diagram illustrating a bottom plate including a first magnet.

### DETAILED DESCRIPTION

In the following, embodiments of the present disclosure will be described in detail with reference to the accompanying drawings to facilitate practice by one of ordinary skill in the art to which the present disclosure pertains. However, the present disclosure may be implemented in various other forms and is not limited to the embodiments set forth herein. In order to clearly illustrate the present disclosure in the drawings, parts irrelevant to the description have been omitted, and like parts throughout the specification are designated by like reference numerals.

Throughout the specification, when a part is stated to be “connected” to another part, this includes not only being “directly connected” but also being “electrically connected” with another element interposed therebetween.

Throughout the specification, when a part is stated to be “on” another part, this includes not only the case that a part is in contact with another part, but also the case that there is another part between the two parts.

Throughout the specification, when a part is stated to “include” a component, it is meant to be further inclusive of other components, not exclusive of other components, unless specifically indicated to the contrary. As used throughout the disclosure, the terms “about,” “substantially,” “substantially,” or the like are intended to be used at or near the numerical value when manufacturing and material tolerances inherent in the recited meanings are given, and are used for clarity to help understand the disclosure and to prevent unscrupulous infringers from taking unfair advantage of the disclosure where precise or absolute numerical values are recited. The terms “steps of” or “steps to” as used throughout the specification do not mean “steps for”.

Hereinafter, preferred embodiments of the present disclosure will be described in detail with reference to the accompanying drawings and the following description. However, the disclosure is not limited to the embodiments described herein and may be embodied in other forms. Throughout the specification, like reference numerals denote like components.

Hereinafter, description will be set forth on a configuration of a cylindrical battery cell according to an embodiment of the present disclosure.

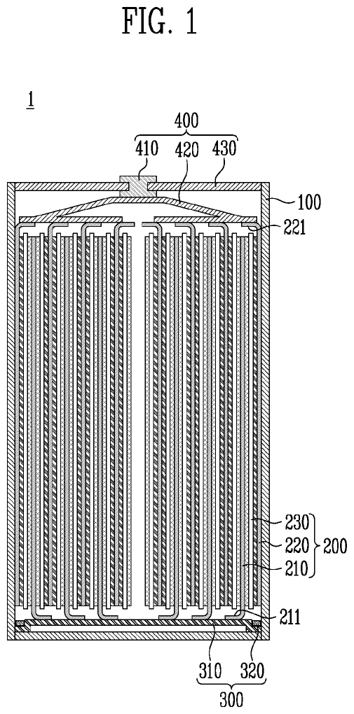

FIG. 1 is a cross-sectional view illustrating a cylindrical battery cell according to an embodiment of the present disclosure.

Referring to FIG. 1, the cylindrical battery cell 1 includes a can 100, an electrode assembly 200, a current collector 300, and a cap assembly 400.

First, the can 100 will be described.

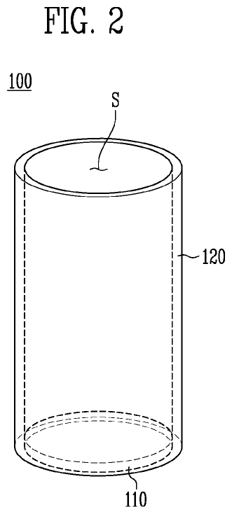

FIG. 2 is a perspective view illustrating the can.

Referring to FIG. 2, the can 100 may be formed in a cylindrical shape with an open top to have a receiving space S formed inside, and a bottom plate 110 located at the bottom may be formed of a magnetic material.

By way of example, as shown in FIG. 2, the can 100 may include a disk-shaped bottom plate 110 and a side plate 120 extending from the bottom plate 110.

In this case, the side plate 120 may be formed separately from the bottom plate 110 to be coupled to the bottom plate 110, or may be integrated with the bottom plate 110.

When the side plate 120 is formed integrally with the bottom plate 110, the side plate 120 as well as the bottom plate 110 may be formed of a magnetic material.

Next, an electrode assembly 200 will be described.

In one embodiment, a cylindrical battery cell 1 may include: a can 100 formed in a cylindrical shape with an open top to have a receiving space formed therein, and having a bottom plate 110 positioned at a lower portion and formed of a magnetic material; an electrode assembly 200 including a first electrode 210 including a first electrode uncoated portion 211 excluding a portion on which a first electrode active material layer is formed and a second electrode 220 including a second electrode uncoated portion excluding a portion on which a second electrode active material layer is formed, wherein a separator 203 is stacked between the first electrode 210 and the second electrode 220, and accommodated in the receiving space; a current collector 300 coupled to the first electrode uncoated portion 211 to be in electrical connection, including a current collector plate 310 having at least a portion coming in contact with the bottom plate 110 to be in electrical connection, and arranged between the electrode assembly and the bottom plate; and a cap assembly 400 including an electrode terminal 410 electrically connected to the second electrode uncoated portion 221 and coupled to a top of the can 100 to seal the receiving space. Further, the current collector 300 may include a magnet 320 and may be prevented from being spaced apart from the bottom plate 110 by an attractive force acting between the magnet and the bottom plate 110.

For example, as shown in FIG. 1, the electrode assembly 200 is an assembly of electrode plates and separators with an electrode active material applied thereto, which includes a first electrode 210 including a first electrode uncoated portion 211 excluding a portion on which a first electrode active material layer is formed and a second electrode 220 stacked between the first electrode 210 and the separator 230 and including a second electrode uncoated portion 221 excluding a portion on which a second electrode active material layer is formed, wherein the electrode assembly 200 may be accommodated in the receiving space S.

Specifically, the first electrode 210 may serve as a negative electrode and may be formed by applying a first electrode active material, such as graphite or carbon, to a first electrode current collector formed from a metal foil, such as copper or nickel.

The first electrode 210 may include the first electrode uncoated portion 211, which is a region to which no first electrode active material is applied, wherein the first electrode uncoated portion 211 may be connected to the current collector 300, which will be described later, to serve as a conduit for current flow between the first electrode 210 and the outside.

The second electrode 220 may serve as a positive electrode and may be formed by applying a second electrode active material, such as a transition metal oxide, to a second electrode current collector formed from a metal foil, such as aluminum.

The second electrode 220 may also include the second electrode uncoated portion 221, which is a region to which no second electrode active material is applied, wherein the second electrode uncoated portion 221 may be connected to an electrode terminal 410, which will be described later, to serve as a conduit for current flow between the second electrode 220 and the outside.

A separator 230 may be located between the first electrode 210 and the second electrode 220 to prevent shorting and to enable the migration of lithium ions. Such separator 230 may be made of polyethylene, polypropylene, or a composite film of polyethylene and polypropylene.

Next, the current collector 300 will be described.

Referring to FIG. 1, the current collector 300 is arranged between the electrode assembly 200 and the bottom plate 110.

In addition, the current collector 300 includes a current collector plate 310 that is coupled to the first electrode uncoated portion 211 to be in electrical connection, at least a portion of which is in contact with the bottom plate 110 to be in electrical connection.

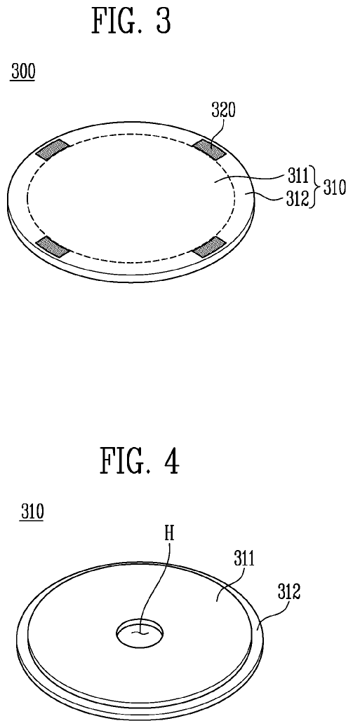

FIG. 3 is a perspective view illustrating a current collector.

Such a current collector 300, as shown in FIG. 3, includes a current collector plate 310 and a magnet 320.

The current collector plate 310 may include a coupling portion 311 having the first electrode uncoated portion 211 coupled thereto, and a seating portion 312 located on an outer circumference of the coupling portion 311.

For example, the coupling portion 311 may be formed in a disk shape and the seating portion 312 may be formed in a ring shape surrounding an outer circumference of the coupling portion 311.

The seating portion 312 may be integrated with the coupling portion 311 to extend from the coupling portion 311 or may be formed separately from the coupling portion 311 and configured to be coupled to the coupling portion 311.

The current collector 300 may include a magnet 320, which may be prevented from being spaced apart from the bottom plate 110 by an attractive force acting between the magnet 320 and the bottom plate 110.

For example, the magnet 320 may be arranged to oppose the bottom plate 110 with at least a portion of the seating portion 312 interposed therebetween to exert an attractive force to the bottom plate 110; the attractive force acting between the magnet 320 and the bottom plate 110 may prevent the seating portion 312 arranged between the magnet 320 and the bottom plate 110 from being spaced apart from the bottom plate 110; and the current collector 300 including the seating portion 312 may also be prevented from being spaced apart from the bottom plate 110.

This magnet 320 may be formed of ferrite magnet or neodymium magnet, but the composition of the magnet 320 is not limited thereto.

In other embodiments, the coupling portion 311 and the seating portion 312 that constitute the current collector plate 310 may have a variety of structures.

FIG. 4 is a perspective view illustrating an example of a current collector plate.

For example, as shown in FIG. 4, the seating portion 312 may be formed to come in contact with the bottom plate 110, and the coupling portion 311 may be formed to have a step with the seating portion 312 such that when the seating portion 312 comes in contact with the bottom plate 110, it may be spaced a predetermined distance from the bottom plate 110.

Further, at least one or more through holes H may be formed in the coupling portion 311. As the through holes H are formed, the first electrode uncoated portion 211 may pass through the through holes H and then be folded and coupled to the coupling portion 311, with the coupling portion 311 interposed therebetween.

In other words, to increase the coupling force between the first electrode uncoated portion 211 and the coupling portion 311, the current collector plate 310 according to an example may be configured to be coupled to the coupling portion 311 as the first electrode uncoated portion 211 is folded, with the coupling portion 311 interposed therebetween.

In this case, a space needs be formed between the coupling portion 311 and the bottom plate 110 in which a portion of the first electrode uncoated portion folded while passing through the through holes H is arranged, but the coupling portion 311 is formed to have a step with the seating portion 312 in contact with the bottom plate 110, so that a space may be formed between the coupling portion 311 and the bottom plate 110 in which a portion of the first electrode uncoated portion 211 may be accommodated.

Thus, the current collector plate 310 may be securely coupled to be in electrical connection with the bottom plate 110 via the seating portion 312.

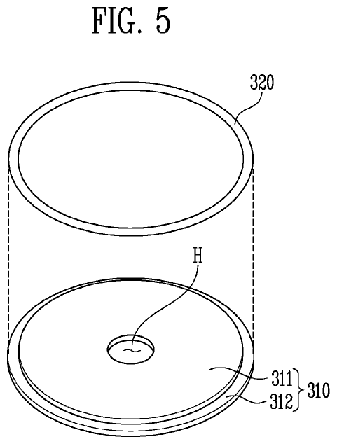

FIG. 5 is a diagram illustrating a view in which a magnet is arranged on a current collector plate according to one example.

In other embodiments, as shown in FIG. 5, the magnet 320 may be formed in a ring shape and may be arranged on the seating portion 312. In other words, the magnet 320 may be arranged to oppose the bottom plate 110 with the seating portion 312 interposed therebetween.

Accordingly, an attractive force may be exerted between the magnet 320 and the bottom plate 110 such that the seating portion 312 arranged between the magnet 320 and the bottom plate 110 is subjected to a force toward the bottom plate 110, and the current collector 300 including the seating portion 312 may be prevented from being spaced apart from the bottom plate 110.

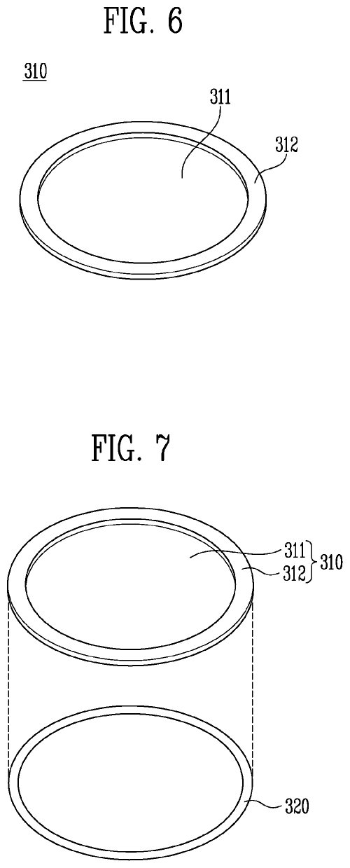

FIG. 6 is a perspective view illustrating another example of a current collector plate.

In another example, as shown in FIG. 6, a coupling portion 311 may be formed to allow the first electrode uncoated portion 211 to be coupled thereto and to be in contact with the bottom plate 110.

Then, a seating portion 312 may be located on an outer circumference of the coupling portion 311 and may be formed to have a step with the coupling portion 311 such that when the coupling portion 311 is in contact with the bottom plate 110, it may be spaced a predetermined distance from the bottom plate 110.

A magnet 320 may be coupled to at least a portion of the seating portion 312 to exert an attractive force to the bottom plate 110.

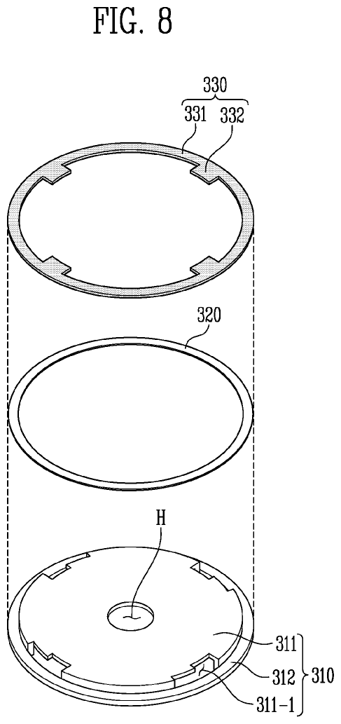

FIG. 7 is a diagram illustrating a view in which a magnet is arranged on a current collector plate according to another example.

By way of example, as shown in FIG. 7, the coupling portion 311 may be formed in a disk shape, and the seating portion 312 may be formed in a ring shape surrounding an outer circumference of the coupling portion 311.

Then, the magnet 320 may be formed in a ring shape to be coupled to the seating portion 312.

In this case, the magnet 320 and the seating portion 312 may be coupled such that they are prevented from being spaced apart from each other. By way of example, the magnet 320 and the seating portion 312 may be bonded to each other via an adhesive.

Accordingly, as an attractive force is exerted between the magnet 320 and the bottom plate 110, the coupling portion 311 connected with the seating portion 312 coupled with the magnet 320 may also be subjected to a force in a direction facing the bottom plate 110, and the current collector 300 including the coupling portion 311 and the seating portion 312 may be prevented from being spaced apart from the bottom plate 110.

In one example, the current collector 300 according to an example may be configured such that the magnet 320 is spaced apart from the support plate 330 to more effectively prevent the current collector 300 and the bottom plate 110 from being spaced.

FIG. 8 is an exploded perspective view illustrating an example of a current collector including a support plate.

Specifically, with reference to FIG. 8, the current collector 300 according to an example may further include a support plate 330.

The support plate 330 may be engaged with the coupling portion 311 to support the magnet 320 to prevent the magnet 320 from being spaced apart from the seating portion 312.

In an example, the coupling portion 311 may have at least one engagement groove 311-1 formed therein.

In addition, the support plate 330 may include a support 331 supporting the magnet 320 and an engaged portion 332 engaged with the engagement grooves 311-1.

As shown in FIG. 8, the engagement groove 311-1 formed in the coupling portion 311 may be formed to allow the engaged portion 332 to be inserted, but may be formed to allow the engaged portion 332 inserted into the engagement groove 311-1 to slidably move along the outer circumference of the coupling portion 311.

The support 331 of the support plate 330 may be formed to support the magnet 320 by opposing the seating portion 312 with the magnet 320 interposed therebetween.

By way of example, the support 331 may be formed in a ring shape to oppose the seating portion 312.

The engaged portion 332 of the support plate 330 may extend from the support 331 toward the center of the support 331, and may be shaped to be insertable into the engagement groove 311-1.

At least one or more of such engaged portions 332 may be provided on the support plate 330, and may be formed on the support plate 330 such that it may be inserted into the engagement grooves 311-1, respectively, when the support plate 330 is seated in the seating portion 312 with the magnet 320 interposed therebetween.

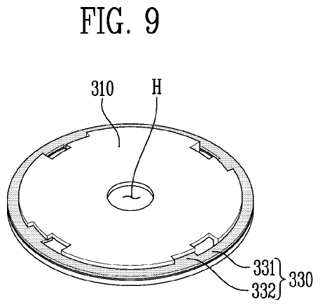

FIG. 9 is a perspective view illustrating an example of a current collector to which the support plate is engaged with the coupling portion.

As shown in FIG. 9, the support plate 330 may be coupled to the current collector plate 310 to oppose the seating portion 312 with the magnet 320 interposed therebetween.

In this case, engaged portions 332, each inserted into at least one or more engagement grooves 311-1, may be slidably moved along the outer circumference of coupling portion 311 upon rotation of support plate 330 so that the upper portion is supported by coupling portion 311.

Thus, the support plate 330 arranged on the seating portion 312 is prevented from being moved away from the seating portion 312, and the magnet 320 arranged between the support plate 330 and the seating portion 312 is prevented from being moved away from the seating portion 312.

Accordingly, the magnet 320 is spaced apart from the current collector plate 310 and is prevented from pressing the current collector plate 310 toward the bottom plate 110, thereby effectively preventing the current collector plate 310 from being spaced apart from the bottom plate 110.

In other examples, the current collector 300 may be configured such that the support plate 330 is spaced apart from the magnet 320 to more effectively prevent the current collector plate 310 from being spaced apart from the bottom plate 110.

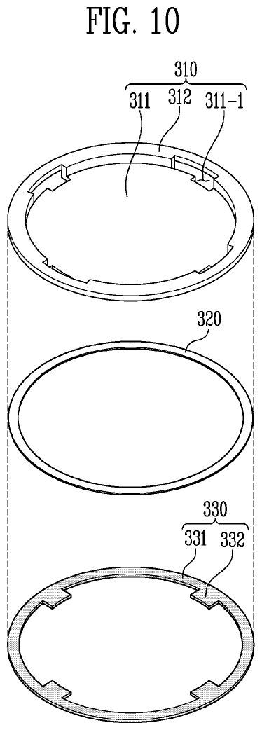

FIG. 10 is an exploded perspective view illustrating another example of a current collector including a support plate.

Specifically, with reference to FIG. 10, the current collector 300 according to another example may further include a support plate 330.

The support plate 330 may be engaged with the coupling portion 311 to support the magnet 320 so as to prevent the magnet 320 from being spaced apart from the seating portion 312.

By way of example, the coupling portion 311 may have at least one or more engagement grooves 311-1 formed therein.

Moreover, the support plate 330 may include a support 331 supporting the magnet 320 and an engaged portion 332 engaged with the engagement grooves 311-1.

As shown in FIG. 10, the engagement groove 311-1 formed in the coupling portion 311 may be formed to allow the engaged portion 332 to be inserted, but may be formed to allow the engaged portion 332 inserted into the engagement groove 311-1 to slidably move along the outer circumference of the coupling portion 311.

The support 331 of the support plate 330 may be formed to support the magnet 320 by opposing the seating portion 312 with the magnet 320 interposed therebetween.

By way of example, the support 331 may be formed in a ring shape to oppose the seating portion 312.

The engaged portion 332 of the support plate 330 may extend from the support 331 toward the center of the support 331 and may be shaped to be insertable into the engagement grooves 311-1.

At least one or more of such engaged portions 332 may be provided on the support plate 330, and may be formed on the support plate 330 to be inserted into the engagement grooves 311-1, respectively, when the support plate 330 is seated on the seating portion 312 with the magnet 320 interposed therebetween.

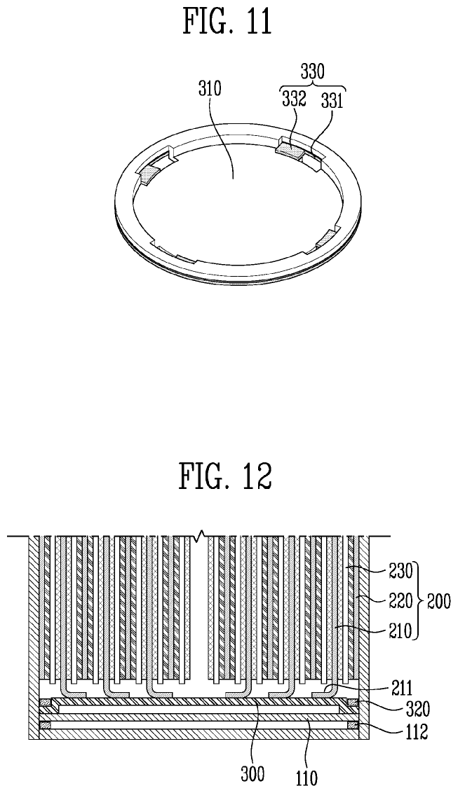

FIG. 11 is a perspective view illustrating another example of a current collector with a support plate engaged with the coupling portion.

As shown in FIG. 11, a support plate 330 may be coupled to the current collector plate 310 to oppose the seating portion 312 with magnet 320 interposed therebetween.

In this case, engaged portions 332, each inserted in at least one or more engagement grooves 311-1, may slidably move along the outer circumference of coupling portion 311 upon rotation of support plate 330 so that the lower portion may be supported by coupling portion 311.

In other words, the support plate 330 may be coupled to the current collector plate 310 and the magnet 320 may be arranged between the seating portion 312 of the current collector plate 310 and the support plate 330, so that the current collector plate 310 is prevented from moving away from the magnet 320.

As a result, the current collector plate 310 is spaced apart from the magnet 320 and moved away from the bottom plate 110, which effectively prevents the current collector plate 310 and the bottom plate 110 from being electrically disconnected.

On the other hand, the bottom plate 110 may also be configured to more effectively prevent the current collector plate 310 from being spaced apart from the bottom plate 110.

Specifically, the bottom plate 110 may include a first magnet 112 that applies an attractive force to the magnet 320, thereby more strongly attracting the current collector plate 310 toward the bottom plate 110.

FIG. 12 is a diagram illustrating a bottom plate including a first magnet.

By way of example, as shown in FIG. 12, the bottom plate 110 may be formed to have a space with a predetermined volume formed therein, and the first magnet 112 may be arranged inside the bottom plate 110.

In this case, the first magnet 112 may be arranged to oppose the magnet 320 with at least a portion of the bottom plate 110 interposed therebetween.

Next, a cap assembly 400 will be described.

As described with reference to FIG. 1, the cap assembly 400 includes an electrode terminal 410 that is electrically connected to the second electrode uncoated portion 221 and may be coupled to the top of the can 100 to seal the receiving space S.

By way of example, as shown in FIG. 1, the cap assembly 400 may include a cap plate 430 covering a top of the can 100 while supporting the electrode terminal 410, and a collecting member 420 that is in electrical connection with the second electrode uncoated portion 221, wherein at least a portion of the collecting member 420 may be configured to be in electrical connection with the electrode terminal 410.

Hereinafter, the operation and effects of a cylindrical battery cell according to an embodiment of the present disclosure will be described.

In the receiving space S of a can 100 with an open top, an electrode assembly 200 and a current collector 300 electrically connected to the first electrode uncoated portion 211 of the electrode assembly 200 are placed.

The current collector 300 is arranged to be in contact with the bottom plate 110 and is configured to include a magnet 320 to exert an attractive force to the bottom plate 110 formed of a magnetic material.

In this way, the magnetic force acting between the current collector 300 and the bottom plate 110 prevents the current collector 300 from being spaced apart from the bottom plate 110, so that the current collector 300 and the bottom plate 110 may be electrically reliably connected without welding the current collector 300 to the inner circumferential surface of the can 100 by forming the can 100 with its bottom open.

In this case, the current collector 300 may further include a support plate 330 to prevent the magnet 320 from being spaced apart from the current collector 300 or to prevent the current collector 300 from being spaced apart from the magnet 320. By having the support plate 330, the current collector 300 and the bottom plate 110 may more reliably maintain contact.

Next, by coupling a cap assembly 400, which is electrically connected to the second electrode uncoated portion 221 of the electrode assembly 200, to the top of the can 100 to seal the receiving space S, a cylindrical battery cell 1 may be manufactured.

Thus, the cylindrical battery cell according to the present disclosure provides the effect that the can and the current collector do not need to be welded on the interior of the can as the current collector and the bottom plate of the can are joined by magnetic force, thus preventing metal debris from remaining on the inside of the can and preventing the electrode assembly from being damaged by heat from welding.

Furthermore, a bend for welding the current collector to the inner circumference of the can is not required to be formed at the lower portion of the can, such that the volume of the inner space of the can is increased, thereby increasing the energy density.

Furthermore, it is not necessary to perform a process to form, at the lower portion of the can, a bend for welding the current collector to the inner circumferential surface of the can, such that manufacturing costs may be reduced.

The foregoing description of the present disclosure is for illustrative purposes only, and one of ordinary skill in the art to which the present disclosure pertains will understand that it may be readily modified to other specific forms without altering the technical idea or essential features of the present disclosure. It should therefore be understood that the embodiments described above are exemplary in all respects and are not intended to be limiting. For example, each component described in a single form may be implemented in a distributed manner, and similarly, components described as distributed may be implemented in a combined form.

The scope of the present disclosure is indicated by the following claims rather than by the detailed description above, and the meaning and scope of the claims and all modifications or variations derived from the equivalents thereof are to be construed to fall within the scope of the present disclosure.

1. A cylindrical battery cell comprising:
a can formed in a cylindrical shape with an open top to have a receiving space formed therein, and having a bottom plate positioned at a lower portion and formed of a magnetic material;
an electrode assembly including a first electrode including a first electrode uncoated portion excluding a portion on which a first electrode active material layer is formed and a second electrode including a second electrode uncoated portion excluding a portion on which a second electrode active material layer is formed, wherein a separator is stacked between the first electrode and the second electrode, and accommodated in the receiving space;
a current collector coupled to the first electrode uncoated portion to be in electrical connection, including a current collector plate having at least a portion coming in contact with the bottom plate to be in electrical connection, and arranged between the electrode assembly and the bottom plate; and
a cap assembly including an electrode terminal electrically connected to the second electrode uncoated portion and coupled to a top of the can to seal the receiving space,
wherein the current collector further includes a magnet and is prevented from being spaced apart from the bottom plate by an attractive force acting between the magnet and the bottom plate.

2. The cylindrical battery cell according to claim 1, wherein the current collector plate includes:
a coupling portion having the first electrode uncoated portion coupled thereto; and
a seating portion located on an outer circumference of the coupling portion, and
wherein the magnet is arranged to oppose the bottom plate with at least a portion of the seating portion interposed therebetween to exert an attractive force to the bottom plate.

3. The cylindrical battery cell according to claim 2, wherein the coupling portion is formed in a disk shape, and
wherein the seating portion is formed in a ring shape surrounding an outer circumference of the coupling portion.

4. The cylindrical battery cell according to claim 3, wherein the seating portion is formed to come in contact with the bottom plate,
wherein the coupling portion is formed to have a step with the seating portion to be spaced a predetermined distance from the bottom plate when the seating portion comes in contact with the bottom plate,
wherein at least one or more through holes are formed in the coupling portion, and
wherein the first electrode uncoated portion is passed through the through holes and then folded to be coupled to the coupling portion with the coupling portion interposed therebetween.

5. The cylindrical battery cell according to claim 4, wherein the magnet is formed in a ring shape and arranged to oppose the bottom plate, with the seating portion interposed therebetween.

6. The cylindrical battery cell according to claim 5, wherein the current collector further includes, to prevent the magnet from being spaced apart from the seating portion, a support plate which is engaged with the coupling portion to support the magnet.

7. The cylindrical battery cell according to claim 6, wherein at least one or more engagement grooves are formed in the coupling portion, and
wherein the support plate includes a support supporting the magnet and an engaged portion engaged with the engagement groove.

8. The cylindrical battery cell according to claim 1, wherein the current collector plate includes:
a coupling portion having the first electrode uncoated portion coupled thereto and formed to come in contact with the bottom plate; and
a seating portion located on an outer circumference of the coupling portion and formed to have a step with the coupling portion to be spaced a predetermined distance from the bottom plate when the coupling portion comes in contact with the bottom plate, and
wherein the magnet is coupled to at least a portion of the seating portion to exert an attractive force to the bottom plate.

9. The cylindrical battery cell according to claim 8, wherein the coupling portion is formed in a disk shape, and
wherein the seating portion is formed in a ring shape surrounding an outer circumference of the coupling portion.

10. The cylindrical battery cell according to claim 9, wherein the magnet is formed in a ring shape to be coupled to the seating portion.

11. The cylindrical battery cell according to claim 10, wherein the current collector further includes, to prevent the magnet from being spaced apart from the seating portion, a support plate engaged with the coupling portion to support the magnet.

12. The cylindrical battery cell according to claim 11, wherein at least one or more engagement grooves are formed in the coupling portion, and
wherein the support plate includes a support supporting the magnet and an engaged portion engaged with the engagement groove.

13. The cylindrical battery cell according to claim 1, wherein the magnet is a ferrite magnet or a neodymium magnet.

14. The cylindrical battery cell according to claim 13, wherein the bottom plate includes a first magnet that exerts an attractive force to the magnet.

15. The cylindrical battery cell according to claim 14, wherein the first magnet is arranged inside the bottom plate.
